(19) United States
(12) Patent Application Publication
(10) Pub. No.: US 2003/0184582 A1
(43) Pub. Date: Oct. 2, 2003

(54) Browser plug-ins

(76) Inventor: Thomas Andrew Cohen, Quedjinup (AU)

Correspondence Address: MOLINS AND CO., LEVEL 25 CHIFLEY TOWER, SYDNEY, 2000, AU

(21) Appl. No.: 10/379,574

(22) Filed: Mar. 6, 2003

(30) Foreign Application Priority Data
Mar. 27, 2002 (AU) PS 1385

(51) Int. Cl. G09G 5/00

(52) U.S. Cl. 345/736

(57) ABSTRACT

The invention provides a family of browser plug-ins, which may be used separately or in combination to assist in the collection, organisation and review of web content and hyperlinks. It will be understood that the invention comprises software for managing information, methods of accumulating and storing information and computer hardware when running the disclosed software. The software will be described with reference to the collection of hyperlinks from pages displayed in a browser window as well as the collection of updateable bookmarks. Various features may be combined into a plug-in for an Internet browser. It is intended that plug-ins and their features may be used alone or in combination with one another.

### FIELD OF THE INVENTION

The invention pertains to the acquisition and management of Internet based information. More particularly the invention relates to a family of browser plug-ins, which may be used separately or in combination to assist in the collection, organisation and review of web content and hyperlinks.

### BACKGROUND OF THE INVENTION

A web page consists of hypertext such as HTML or XML within which is contained text information, images, hyperlinks and other classes of data. When a browser user requests a web page, the page is displayed visually on the user's browser. If the displayed page contains hyperlinks, there exists at least a possibility that the user will follow the hyperlinks to the referenced resource.

Currently known browsers do not allow a user to collect referring hyperlinks other than by “cutting and pasting”. Another method of collecting hyperlinks is to select a referring hyperlink and allow the referenced page to load, then create a bookmark from the referenced Uniform Resource Locator (“URL”). These methods are considered cumbersome and inefficient.

Current browsers are also somewhat inefficient with respect to machine resources in that they do not cache or pre-load a referenced document until such time as a user selects a referring link. The user is then required to wait while the referenced content loads.

Current browsers also manage collected bookmarks without reference to maintaining the currency of the referred content of a bookmark and by failing to provide users with keywords or Boolean search strings which are associated to bookmarked content.

### OBJECTS AND SUMMARY OF THE INVENTION

It is an object of the invention to provide methods and software to enhance a user's browsing experience.

It will be understood that the invention comprises software for managing information, methods of accumulating and storing information and computer hardware when running the disclosed software. The software will be described with reference to particular features. Various features may be combined into a plug-in for an Internet browser. It is intended that plug-ins may be used alone or in combination with one another.

### BRIEF DESCRIPTION OF THE DRAWING FIGURES

FIG. 1 is a depiction of a PC screen showing a collapsed browser window, in which browser a plug-in of the present invention has been installed, together with a window generated by the plug-in;

FIG. 2 is a depiction of a PC screen showing a browser window, in which browser a plug-in of the present invention has been installed and showing a menu for displaying and managing collected bookmarks;

FIG. 3 is a depiction of a window generated by a plug-in of the present invention;

FIG. 4 depicts bookmark management menus accesses from the taskbar of a PC.

### BEST MODE AND OTHER EMBODIMENTS OF THE INVENTION

Through out the following specification, the word “application” is used to refer to a software application which embodies one or more of the features described below. It will be understood that these one or more applications refer primarily to browser plug-ins although one or more features of the present invention may be embodied into a special purpose browser or stand alone program.

Accordingly, the invention allows a web user to collect any number of hyperlinks for later review by way of ‘drag and drop’ and without having first to load the referenced pages, to open multiple browsers or to leave the page currently loaded in the browser (the referencing page displaying the hyperlink). The collected hyperlinks are displayable in list form in a window launched by the collecting application or in a browser window. This feature may be provided as a separate plug-in.

The invention also provides for certain content on the web pages referenced by the collected hyperlinks to be pre-loaded into a cache (while the user continues to view the referencing page) so that when they are accessed at a later stage they are more readily available (even offline). These features may be provided as a separate plug-in.

The invention additionally permits users to bookmark sites, particularly for regular or repeated viewing over a period of time, whereby certain content and the URL of each site is stored in or accessed by means of a structured directory on the user's PC or machine. The bookmark list (or in a further implementation of the invention each item in the bookmark list individually) can be assigned an automatic update schedule such that without further user intervention the cached content associated with each bookmark will be updated with the most recent version of the content published on the target site; the most recent version can be compared to the version already held in the cache at the time the most recent version is acquired; and the user can be alerted to the fact that there have been changes (by, or example, and icon adjacent to that item's listing in the bookmark menu). Optionally, on opening that file, the user may see a ‘compared version’ rendering of the content, whereby the new content is highlighted (and deletions are marked in a distinctive way). These features may be provided as a separate plug-in.

In a further optional feature or plug-in, user defined keywords or Boolean search strings may be stored in the application (either by direct input, or imported from a website). These keywords can be used in either of two ways: first, they may be highlighted on any pages displayed from the cache, so that a user can see immediately that content of interest is on a particular page; and second, they may form the basis of the alerts regarding changes to content in the bookmark cache—such that an alert of an update to cached content will only be triggered if the new material contains one or more of the keywords. Separate highlight colors may be applied or assigned, either automatically or by user selection, to separate keywords.

In a final optional enhancement or alternative implementation of the product, or separate plug-in, the keywords/strings identified in the previous paragraph can be set to be applied to any page loaded in a web browser such that matching items are highlighted. While similar to the ‘Find’ function in Microsoft's Internet Explorer, or the ‘HighLight’ function in Google's toolbar, this function permits multiple search terms and strings to be stored on the users machine and applied concurrently and iteratively to every web page visited. Separate highlight colors may be applied or assigned, either automatically or by user selection, to separate keywords.

The invention will be particularly useful in the following exemplary situations:

a) long pages of coherent text with numerous links to related content;

b) front pages of news sites, multi-page sites and stories, comparison engines, message boards, etc. where a user will be able to ‘order’ the pre-loading of all stories/items of interest linked from the current page, while reading a first page/story; and

c) regularly visited sites which update from time to time.

The invention makes efficient use of otherwise unused machine time while a user is reading a page or engaged in other activities, and concurrently creates a convenient and manageable database of user-specific content.

Implementations of the invention embodying some of the functions identified above will be represented by one or more plug-ins to a browser control panel (at a minimum Microsoft IE5.0+). There will be three primary user controls: (1) set up/preferences; (2) show results; and (3) view/manage bookmarks list. The application or applications of the present invention will be always on—so there is no activate/deactivate or log in (although the importation of keywords from a website may require entry of a username and password into a pop up dialogue box).

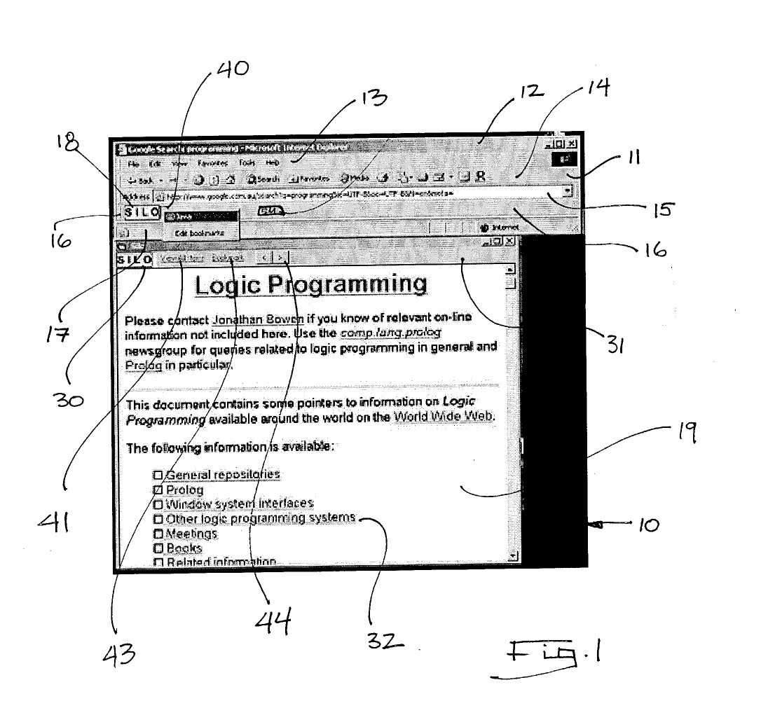

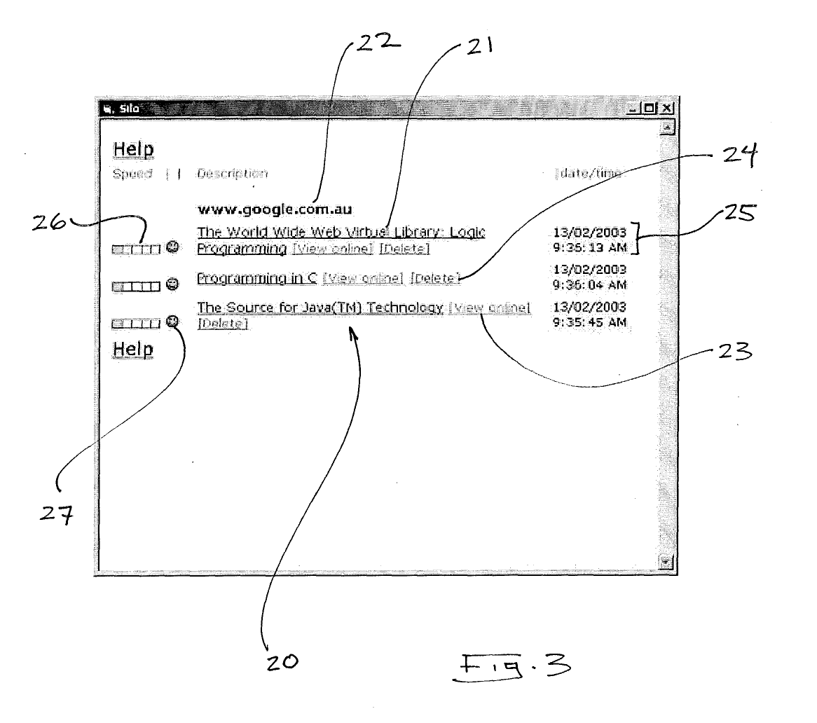

FIG. 1 shows a PC screen 10 in which is displayed two windows. The upper window 11 is a browser window. The main view area has been essentially collapsed (for the sake of this illustration) so that the window shows only the title bar 12, menus 13 toolbar 14, address window 15, the toolbar of the present invention 16 and the status bar 17 which is normally found at the bottom of a browser page. With the plug-in installed, a user is able to select a hyperlink from the normal display window (not shown) and drag the hyperlink to a logo 18 on the toolbar 16. This has the effect of storing that link to the application's cache and making the link available for editing and placement into a displayable list (see FIG. 3) but will not result in any navigation. A link listed in this way will be accompanied by the storage and display of content or context information similar to that provided in search engine results: title, extract, URL, time or collection and a graphic representation of the speed of the link. Each collected hyperlink will be stored in the cache grouped by the top level domain (‘TLD’) of the site from which the hyperlink was collected. The application will optionally store content associated with the URL. However, it might only store a convenient portion of the content such as text only, text formatted according to a style sheet, or formatted text and graphics. The extent of the URL's content stored may be determined by the application or according to user defined preferences.

When the ‘show results’ option is selected (for example by clicking on the logo 18), the collected results 20 will be displayed in a separate window in reverse chronological order (newest first) in groups, under each TLD on a formatted HTML page, as shown in FIG. 3. As shown there the listing comprises the TLD 22, a link displayed as a referred URL's title 21, a link (or button) to view the source on-line 23, a link (or button) to delete the item in the list 24, the date and time of collection 25, an indication of the speed of the download of the item 26 and an indication of whether or not the cached version of the referred page is currently available 27. Clicking on the title 21 requests the stored content from the application's cache. This will load the cached page in the same window in which the cache items were listed (or optionally into a browser). A user will be able to go back to the list at any time by clicking on the logo 18 or another button on the user interface (control panel) of the window, preferably within the plug-in's toolbar 16.

As shown in FIG. 1, when the application's cache display window 19 is displaying a cached item, a logo 30 will be visible on the cache display window's control panel 31 so that links 32 within the cached item can be dragged to the logo 30 for caching (as with links from the original referring web pages). If a user clicks on a link 32 in a cached item, a new browser window will be opened and the referenced site loaded in the conventional manner. This involves, during the caching, the conversion to absolute links of all relative links within the content. For any item in the application's cache, users will have the option of viewing the online version instead of the cached version—this will open a new browser and load the referenced site in the normal manner. The toolbar 31 of the application's cache display window 19 also has a button or device 42 for viewing the window displaying the cached link list (FIG. 3), a button 43 for bookmarking the displayed, cached page's URL and buttons for navigating 44 as required forwards or backwards sequentially through the cached link list (FIG. 3) . . . .

The invention will pre-load the pages referenced in collected hyperlinks. Pages will be fetched in the order in which hyperlinks are collected. All or some of the contents of a page referenced by a saved hyperlink will be grabbed in background mode (optionally including some, all or none of the associated style sheet graphics and active components such as Java applets, streaming media, Flash animations and ActiveX controls). The software of the invention will save the contents to its cache. Relative links in the pre-loaded content are made absolute.

In an optional implementation, the invention will scan cached content so as to create a dynamic list of keywords according to an algorithm based on weighted occurrences of words common to the collected hyperlink's context (including page title) and the reference page's URL and title, as well as any title text and the TLD itself.

These keywords (which are different to the user defined keyword/strings above, and are used for a different purpose) will be stored in the application's database (associated with the relevant hyperlinks) for later use. In this implementation, the software of the present invention will communicate with a server (no login required) to retrieve matching information for the keywords (information such as ads, content or additional URLs). Any matching information will be downloaded and stored for display in defined locations within the application's windows. Information such as, ads stored in the application's database will be deleted and/or updated after a definable time in the cache. Additional URLs stored in the application's cache will be deleted and/or updated on a further definable schedule.

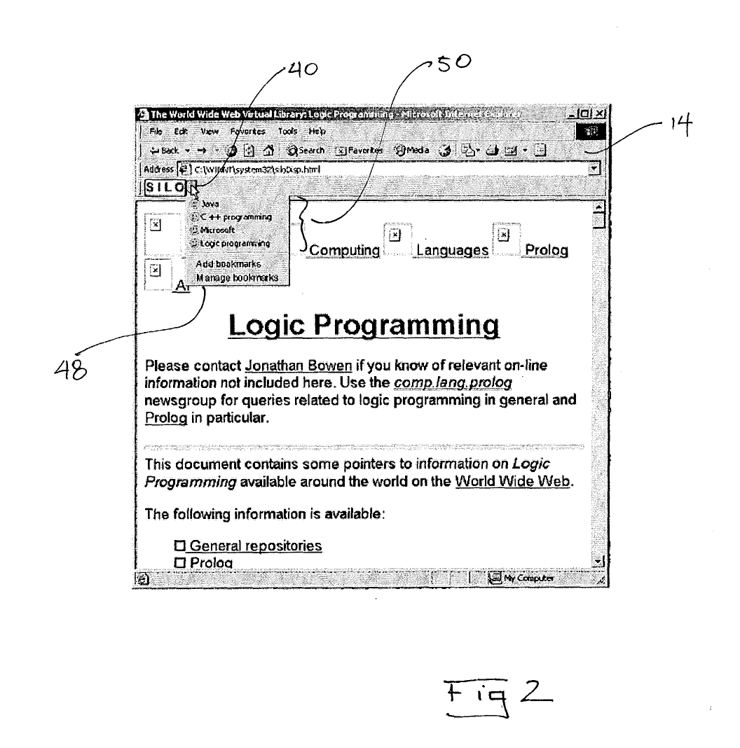

As shown in more detail in FIG. 2, preferred embodiments of the invention provide for the plug-in software to introduce into the user's selected browser, two primary changes to the toolbar 14. The first is the plug-in's logo 18 which acts as a button for launching the stored link list window (FIG. 3) and also as a destination to which links can be dragged off of the main view portion of the browser. As shown there, the toolbar 14 also has a second button 40. The second button 40, when activated causes a drop down menu 48 to appear. In this example, the upper portion of the menu displays a list of the bookmarked pages 50, any of which can be selected for viewing by mouse action or keyboard commands. The bottom of the menu 48 has commands which lead to windows where tasks can be performed. Tasks may include the management of bookmarks or the addition or deletion of bookmarks or the assignment of update frequencies to the bookmarks or the storing of keywords or Boolean search strings.

When a cached item is displayed in the application's window 19, a command accessed via a button 40 on the toolbar or menu 48 or control panel 16 will allow users to bookmark the displayed site and to add a title by which the site will be identified in a bookmark list. Clicking on the bookmark icon 40 will display the bookmark list as well as ‘Add Bookmark’ and ‘Manage Bookmarks’. The ‘Add Bookmark’ function allows the user to add manually a bookmark to the list—this can be any desired URL or the URL displayed at that time in the browser. The user will be able to define a title for the bookmark. The ‘Manage Bookmarks’ function allows the user to delete or rename items in the bookmark list and to set (for all bookmarks or optionally for each item individually) an automatic update schedule (from a menu or options—e.g. twice a day, daily, once a week, etc.). A user will also be able to force a manual update for all bookmarks, or optionally for any particular bookmark by clicking an ‘Update Now’ button adjacent to the item title in the Manage Bookmarks window.

The format of the Manage Bookmarks window will be substantially the same as the cache window (as shown in FIG. 2)—it will display, inter alia, a graphic representation of the link speed to the target site as determined at the most recent download, the user's defined title for each item, the last downloaded date and a graphic indication of whether or not the content has been updated since it was last viewed. In an optional version a further feature of the Manage Bookmarks function will allow users to store a set number of keywords/strings and/or to import such terms from a related site—and to have those terms used to filter updates on content in the Bookmark List—such that an update is only flagged if the new material on the site contains one or more of the user's keywords/strings. The windows of the software of the present invention are capable of being updated dynamically while open—so that, for example, the status of an item can change or new items can appear.

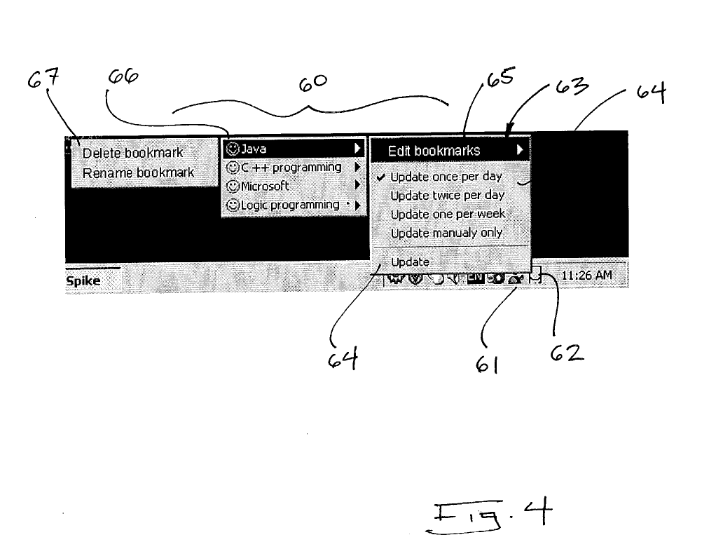

As shown in FIG. 4, the functionality of the plug-in to the browser can also be accessed from pop up menus 60 which are available from the system tray 61. Configuration of the plug-in can result in the display of an icon 62 in the system tray. Clicking on the icon produces the first pop up menu 63 which has menu items or commands 64 for the update frequency as well as an item 65 for editing the bookmarks. Selection of this item 65 produces a second pop-up menu 66 which provides a list of the stored bookmarks, by title. Selection from the menu 66 opens a third pop-up menu 67 with commands such as “delete bookmark” or “rename bookmark” which in turn lead to dialog boxes or windows in which these editing functions may be performed.

While the present invention has been described with reference to particular examples, these should be understood as having been provided as examples and not as limitations to the scope or spirit of the invention as set out in the claims.

What is claimed is:

1. Software for a browser plug-in having machine readable code for performing the following steps:
collecting hyperlinks for later review by providing a user the ability to drag and drop selected words, text or images comprising a link from a display of content in a browser window to a location on a toolbar or control panel of the browser; then
storing the selected hyperlinks; and
providing the user with a button on the browser toolbar or control panel which allows the user to request the display in a first window of a list of the collected hyperlinks, from which content referenced by a hyperlink in the list may be displayed in a the first or a second window.

2. The software of claim 1, further comprising machine readable code for:
requesting and caching content referred to by collected hyperlinks, after a user has collected a hyperlink, but without user intervention after the link has been collected.

3. The software of claim 2, further comprising machine readable code for:
displaying, in the first window, additional information associated with each collected hyperlink, the additional information comprising an indication, adjacent to a listed hyperlink, of the currency of the cached pages which correspond to the hyperlink.

4. The software of claim 3, further comprising machine readable code for:
displaying, in the first window, further information associated with each collected hyperlink, the further information comprising an indication, adjacent to a listed hyperlink, of the speed at which the cached pages were downloaded.

5. The software of claim 2, further comprising machine readable code for:
displaying, in the first window and adjacent to a listed hyperlink a button or hyperlink for deleting a listed hyperlink.

6. The software of claim 2, further comprising machine readable code for:
displaying, in the first window and adjacent to a listed hyperlink a button or hyperlink for viewing the on-line content associated with a listed hyperlink.

7. Software for a browser plug-in having machine readable code for performing the following steps:
providing on a toolbar or control panel of a browser, a button for creating a bookmark based on the page displayed in the browser,
storing the URL and retrieving and storing to a cache, content from the URL,
providing the user with a window in which is displayed a structured display in which the bookmarks are displayed and providing an update schedule whereby the content is updated with a most recent version published on the URL.

8. The software of claim 7, further comprising machine readable code for:
allowing the user to determine a separate update schedule for each bookmark individually.

9. The software of claim 7, further comprising machine readable code for:
storing a value, being a user defined input, keyword or Boolean search string, then using the value to highlight, on a page cached by the software, text which corresponds to the value.

10. The software of claim 9, wherein:
the value is downloaded from a website.

11. The software of claim 7, further comprising machine readable code for:
storing a value, being a user defined keyword or Boolean search string, then using the value to generate an alert to the user when the content published at a URL is updated and the updated content of the updated URL contains the value.

12. The software of claim 11, wherein:
the value is downloaded from a website.

13. Software for a browser plug-in having machine readable code for performing the following steps:
storing a value, being a user defined keyword or Boolean search string, then using the value to highlight on a page cached by the browser or the plug-in, text which corresponds to the value.

14. The software of claim 13, wherein:
the value is downloaded from a website.

15. The software of claim 13, further comprising machine readable code for:
storing a value, being a user defined key work or Boolean search string, then using the value to generate an alert to the user when the content published at a URL is updated and the content of the updated URL contains the value.

16. The software of claim 15, wherein:
the value is downloaded from a website.

17. The software of claim 13, further comprising machine readable code for:
displaying in any page displayed by the browser, a highlighted portion corresponding to the value.

18. The software of claim 7, wherein:
a user alert is generated whenever an update is performed and the content of the URL changes.

19. The software of claim 9, wherein:
the user defined input comprises a plurality of keywords or Boolean search strings and a separate highlight color is assignable to each one.

20. The software of claim 7, wherein:
the content stored comprises a portion of the content published, the portion including at least a text portion.

21. Software for a browser plug-in having machine readable code for performing the following steps:
scanning the content of one or more cached items and using an algorithm to identify one or more keywords based on the scanned content;
storing the one or more keywords, then using the one or more keywords to retrieve information from a server; and
displaying the information in a window, to a user of the plug-in.

22. The software of claim 21, wherein:
the one or more keywords are based on the occurrences of words occurring in cached content.

23. The software of claim 22, wherein:
the keywords are based on the occurrences of words occurring in the URL, or page title or the cached content.

24. The software of claim 21, further comprising machine readable code for:
the information is an advertisement, a URL or content.

25. The software of claim 21, further comprising machine readable code for:
storing the information, then deleting or updating the information according to a schedule.
